(19) United States
(12) Patent Application Publication
(10) Pub. No.: US 2011/0146071 A1
(43) Pub. Date: Jun. 23, 2011

(54) THERMAL ROUNDING SHAPED OPTICAL FIBER FOR CLEAVING AND SPLICING

(75) Inventors: Wenxin Zheng, Moore, SC (US); Bryan Malinsky, Simpsonville, SC (US); Doug Duke, Simpsonville, SC (US)

(73) Assignee: AFL TELECOMMUNICATIONS LLC, Spartanburg, SC (US)

(21) Appl. No.: 13/060,637

(22) PCT Filed: Oct. 6, 2009
(86) PCT No.: PCT/US09/59664

§ 371 Date: Feb. 24, 2011

Related U.S. Application Data
(60) Provisional application No. 61/103,006, filed on Oct. 6, 2008.

(51) Int. Cl. G02B 6/255; H02G 1/14; G02B 6/00

(52) U.S. Cl. 29/869; 225/2; 264/1.24

(57) ABSTRACT

A method of thermally rounding a section of a non-circular optical fiber is provided. The method includes heating the section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular.

### CROSS-REFERENCE TO RELATED PATENT APPLICATION

This application claims the benefit of U.S. Provisional Application No. 61/103,006, filed on Oct. 6, 2008 in the United States Patent and Trademark Office, the disclosure of which is incorporated by reference in its entirety.

### BACKGROUND OF THE INVENTION

1. Field of the Invention

Methods consistent with the present invention relate to thermally rounding a section of a non-circular shaped optical fiber.

2. Description of the Related Art

Optical fiber is widely employed for telecommunications and many other uses. A typical optical fiber for telecommunications use is shown in FIG. 1 and includes a core (130) surrounded by a cladding (120) that is surrounded by a protective coating (110). The cladding (120) is typically pure silica glass. The core (130) is typically doped with trace amounts of germania in order to raise the index of refraction of the core (130) relative to the cladding (120). The coating (110) is typically an acrylate plastic material that serves to protect the glass optical fiber from damage.

A double-clad optical fiber is an optical fiber that has a relatively small-diameter core and two layers of large-diameter cladding. An example of a double-clad optical fiber is shown in FIG. 2. The structure of the double-clad optical fiber appears identical to that of the telecommunications optical fiber shown in FIG. 1, but there are functional differences between the components of the telecommunications optical fiber shown in FIG. 1 and the double-clad optical fiber shown in FIG. 2. In a typical double-clad optical fiber, both of the cladding layers (150, 160) have lower refractive indices than the core (130), and the inner cladding (150) has a higher refractive index than the outer cladding (160). This allows the inner cladding (150) to carry light having a different wavelength from light propagating in the core (130). In some double-clad optical fibers the outer cladding (160) is an acrylate plastic like the protective coating (110) of the telecommunications optical fiber, but the acrylate plastic of the outer cladding (160) of the double-clad optical fiber is a special material that has a lower index of refraction than the inner cladding (150). If the outer cladding (160) is an acrylate plastic, it may be stripped off of the inner cladding (150) for operations such as splicing a double-clad fiber to another component. In such a case, the low-index outer cladding (160) is reconstituted after splicing to restore the low index layer that is required for the optical properties of the double-clad fiber. Alternatively, the outer cladding (160) may be a glass material similar to the inner cladding (150) and the core (130).

Double-clad optical fibers are widely used in fiber amplifiers and fiber lasers. The core (130) of a double-clad optical fiber can be doped to act as the gain medium, while the inner cladding (150) carries pump light that maintains the population inversion in the core (130). The inner cladding (150) of a double-clad optical fiber may have a circular cross-section. However, in double-clad optical fibers with a circular inner cladding (150), a number of helical modes carry the pump energy and travel within the inner cladding (150) without intersecting the core (130). Therefore, these helical modes cannot be used to pump the core (130).

One method of reducing the helical modes in the inner cladding (150) is to promote “mode mixing” by changing the shape of the inner cladding (150). Many different shapes of the inner cladding (150) have been developed and tested. The most cost-effective and popular cross-sectional shapes for the inner cladding (150) are hexagonal and octagonal. An example of a hexagonal optical fiber is shown in FIG. 3A, and an example of an octagonal optical fiber is shown in FIG. 3B. In these non-circular shaped optical fibers, the hexagonal or octagonal inner cladding (150) may be made of glass, while the circular outer cladding (160) may be made of plastic. These non-circular shaped optical fibers have been widely used in erbium-doped and ytterbium-doped fiber amplifiers and fiber lasers.

However, it is difficult to cleave and splice these non-circular shaped optical fibers, because most related art cleavers and splicers are designed for optical fibers with a circular cladding or a partially circular cladding, such as D-shaped fiber. Before cleaving a double-clad optical fiber that has a plastic outer cladding (160), the outer cladding (160) is removed from a portion of the optical fiber from the section of the optical fiber to be cleaved to the position at which the optical fiber is clamped in the cleaver. Therefore, the inner cladding (150) of the optical fiber is held by and rests against the cleaver. Because the inner cladding (150) of a hexagonal or an octagonal fiber consists of flat planes and corners, it is difficult for most related art cleavers to properly cleave these optical fibers. When loading a non-circular shaped optical fiber randomly into a cleaver, the cleave angle may be acceptable if the optical fiber happens to be clamped on one of the flat cladding surfaces. However, if the optical fiber is clamped on one of the corners, the fiber will typically twist about its axis as the flat surfaces of the inner cladding (150) self-align to the flat surfaces of the clamps in the cleaver. This induces torsion and twisting stress in the optical fiber and the cleave angle will be unacceptably high due to the fiber twist and torsion. The cleaver blade may also be damaged by attempting to cleave at this location.

Non-circular shaped optical fiber also presents challenges when splicing, because the optical fiber may not be recognized by the profile alignment system (PAS) of the fusion splicer. Also, it may not be possible to perform core alignment with the non-circular shaped optical fiber, resulting in a higher splice loss for optical fibers with large core-to-cladding concentricity errors. The PAS method is illustrated in FIG. 4 for a single mode optical fiber. As shown in FIG. 4, collimated light (290) from a light-emitting diode (LED) is incident on the side of the single mode optical fiber. The path of the collimated light (290) changes as it travels through the optical fiber, and the intensity of the transmitted light at the focal plane (210) is recorded in an image (as shown on the right-hand side of the figure).

The collimated light (290) first enters the cladding (120) of the optical fiber. The optical fiber cladding (120) is typically made of silica glass and has a higher index of refraction than the air through which the collimated light (290) was transmitted. The collimated light (290) is bent at the air-glass interface due to the difference in the index of refraction between the air and the glass and the incident angle at the interface. The collimated light (290) that enters at the center of the cladding (120) continues in a straight path without bending because the incident angle is 90 degrees. Just to either side of the center of the cladding (120), the collimated light (290) bends slightly inwards toward the center of the cladding (120) because the incident angle is slightly greater than 90 degrees. Farther away from the center of the cladding (120), the collimated light (290) bends more sharply towards the center of the cladding (120) because the incident angle is larger. The cladding (120) therefore acts as a focusing element for the collimated light (290) as shown in FIG. 4. The core (130) of the single mode optical fiber has a higher index of refraction than the optical fiber cladding (120) and therefore acts as a secondary focusing element.

The bending of the previously collimated light (290) results in a brightness intensity profile (220) at the focal plane (210) which is plotted in the center of FIG. 4. The focusing effect of the cladding (120) results in all of the originally collimated light (290) being concentrated into the bright center region (250) of the fiber image. Outside of the bright center region (250), the fiber image is completely black due to the absence of any light as shown in the outer positions (240). In the center of the bright center region (250) there is a bright center peak (260) in the brightness intensity profile (220). The presence and position of the bright center peak (260) is due to the secondary focusing effect of the optical fiber core (130). The position of the bright center peak (260) in the brightness intensity profile (220) allows the profile alignment system to determine the position of the optical fiber core (130) within the cladding (120). This determination enables alignment of the cores (130) of two optical fibers and thereby promotes joining and splicing of two optical fibers with low loss of the transmitted optical signal carried by the fibers.

In the case of a hexagonal or octagonal optical fiber, the flat surfaces defining the shape of the inner cladding (150) as shown in FIGS. 3A and 3B would result in the incident collimated light (290) being refracted in various directions instead of being focused towards the center of the hexagonal or octagonal inner cladding (150) as in the case of a circular fiber. The directions in which the incident collimated light (290) would be refracted would depend upon the orientation of the hexagonal or octagonal shape of the optical fiber inner cladding (150) relative to the direction of the collimated light (290). Since the orientation of the hexagonal or octagonal optical fiber inner cladding (150) to the collimated light (290) is random, the directions in which the collimated light (290) is bent will also be random. The result is that in the case of a hexagonal or octagonal optical fiber, it is not possible for the profile alignment system to determine the position of the optical fiber core (130) within the hexagonal or octagonal inner cladding (150). Therefore, core alignment cannot be preformed by the profile alignment system, and low loss splicing cannot be consistently performed.

An alternative method to align the cores of two optical fibers is to inject light into the end of one optical fiber and detect the received optical power from the far end of the second optical fiber using a power meter. This method works well for most optical fibers because any optical power outside of the core in the cladding tends to dissipate within a short length of fiber. Therefore the received power at the power meter represents only the optical power propagated inside the fiber core, and is a measure of the quality of the alignment of the cores of the two fibers. However, double-clad fibers such as octagonal and hexagonal fibers are designed to propagate optical power in both the core and the inner cladding. Therefore the method of aligning the two fibers until maximum received power is received by the power meter typically will not successfully result in alignment of the cores of the two fibers because it is not possible to differentiate between the received optical power in the core of the optical fiber and the optical power in the inner cladding.

In addition, in the case of polarization-maintaining optical fiber, the rotational alignment of polarization states of two non-circular optical fibers cannot be aligned by the PAS optical analysis, because the optical system cannot discern the polarization-maintaining structure within the non-circular inner cladding of the optical fiber. FIG. 5 shows a circular polarization-maintaining PANDA optical fiber with two rotational orientations with respect to a profile alignment system. Collimated light (290) from a light-emitting diode (LED) is incident on the side of the circular polarization-maintaining optical fiber cladding (120), and the intensity of the transmitted light at the focal plane (210) is recorded in an image (as shown on the right-hand side of the figure). The incident collimated light (290) is focused towards the center of the polarization-maintaining optical fiber as described above. In this case, the brightness intensity profile (220) as detected at the focal plane (210) is determined by the bending of the formerly collimated light (290) as it enters the fiber cladding (120), the further bending at the interface of the optical fiber core (130) and cladding (120), and other elements in the refractive index profile of the polarization-maintaining fiber. In the case of the PANDA polarization-maintaining optical fiber shown in FIG. 5, there are two stress rods (140) inside the fiber structure. These stress rods have a different material composition than the optical fiber cladding (120), and are located in the cladding (120) on either side of the optical fiber core (130). The presence of the stress rods (140) results in a permanent asymmetrical stress within the optical fiber, and this produces the polarization-maintaining properties of the optical fiber in which two orthogonal polarization states are maintained. The stress rods (140) have a lower index of refraction than the fiber cladding (120), and the presence of the stress rods (140) as well as the core (130) within the optical fiber cladding (120) results in a complicated pattern of bending of the originally collimated light (290).

A PANDA fiber may be rotated until specific points (230) in the brightness intensity image profile (220) have approximately the same height. This only occurs when the PANDA fiber is rotated such that the stress rods (140) lie in a plane perpendicular to the focal plane (210) as shown in the upper image in FIG. 5, or lie in a plane parallel to the focal plane (210) as shown in the lower image in FIG. 5. When the stress rods (140) lie in a plane perpendicular to the focal plane (210), the specific points (230) in the brightness intensity image profile (220) have the greatest intensity and are further apart than the case in which the stress rods (140) lie in a plane parallel to the focal plane (210). The method of rotating the polarization-maintaining optical fiber until the specific points (230) in the brightness intensity profile (220) have approximately the same height can therefore be used to rotationally align the polarization axes of a PANDA polarization-maintaining optical fiber.

FIG. 6 shows a pair of PANDA polarization-maintaining optical fibers that have been aligned to each other by this method. However, with a hexagonal or octagonal polarization-maintaining optical fiber, the flat surfaces comprising the shape of the inner cladding (150) as shown in FIGS. 3A and 3B would result in the incident collimated light (290) being refracted in various directions, instead of being focused towards the center of the hexagonal or octagonal inner cladding (150) as in the case of a circular fiber. Since the orientation of the hexagonal or octagonal inner cladding (150) relative to the collimated light (290) is random, the directions in which the collimated light (290) is bent will also be random. Therefore, in the case of hexagonal or octagonal polarization-maintaining optical fiber, it is not possible for the profile alignment system to perform the rotational alignment of the polarization axes of the optical fiber.

The Nyfors CleaveMaster LDF has been developed to address the problems with cleaving non-circular shaped optical fibers. The CleaveMaster is a cleaver that is designed to cleave large diameter optical fibers from 250 to 1000 μm. The CleaveMaster uses an image processing system to cleave and splice different fiber types and shapes, including circular, hexagonal, octagonal, and D-shaped fibers. The image processing system automatically detects the fiber shape and rotates the optical fiber into position for cleaving and splicing. The built-in microprocessor controls the parameters and settings, such as fiber alignment, clamping, fiber tension, and the position and speed of the diamond blade. As shown in FIG. 7, the CleaveMaster consists of a front section that utilizes a rotation clamp (910) to grasp the optical fiber (100) and rotate the optical fiber (100) about its optical axis in the rotational direction shown (990). The inward-facing arrows on the rotation clamp (910) indicate the clamping direction used by the rotation clamp (910) to grasp the optical fiber (100). Also located in the front section of the CleaveMaster are an end-view camera (920) and a first fiber holder location (930) for a removable fiber holder (970). In FIG. 7 the removable fiber holder (970) is shown loaded into the first fiber holder locations (930) with the optical fiber (100). The front section of the CleaveMaster is used to rotationally orient the fiber so that good cleave quality will subsequently be possible. The actual cleaving is performed in the rear section of the CleaveMaster, which includes a second fiber holder location (940) for the removable fiber holder (970), a cleaving blade (950), and a fiber tensioning clamp (960) which clamps the optical fiber (100) and applies a tensile force to the optical fiber (100). The arrows on the fiber tensioning clamp (960) indicate the clamping direction used by the tensioning clamp (960) to grasp the optical fiber (100). The tensioning clamp applies tension to the optical fiber along the direction (980) shown. The removable fiber holder (970) and the optical fiber (100) are shown in dashed lines in the secondary location in the rear section of the CleaveMaster where the removable fiber holder (970) has been loaded into the second fiber holder location (940).

The operation of the CleaveMaster is initiated by clamping the optical fiber (100) into the removable fiber holder (970) and loading the optical fiber (100) in the removable fiber holder (970) into the first fiber holder location (930). The rotation clamp (910) then grasps the optical fiber (100), and the clamp of the removable fiber holder (970) is released to enable free rotation of the optical fiber (100) about its axis in the indicated direction (990). The end-view camera (920) analyses the shape of the optical fiber (100) and the orientation of its non-circular shape. An image of the inner cladding of an octagonal optical fiber from the CleaveMaster optical system is shown in FIG. 8. Based on the camera analysis, commands are issued by the CleaveMaster microprocessor to rotate the rotation clamp (910) until one opposing pair of the flat surfaces of the octagonal or hexagonal optical fiber (100) are vertical. Once the rotational alignment is complete, the clamp of the removable fiber holder (970) is again closed so the removable fiber holder (970) firmly grasps the optical fiber (100). The rotation clamp (910) is released to enable the removable fiber holder (970) and optical fiber (100) to be removed from the first fiber holder location (930) and transferred to the second fiber holder location (940). The fiber tensioning clamp (960) engages and clamps the optical fiber (100). There should be no torsion or twisting stress applied to the optical fiber (100) by the tensioning clamp (960), because the flat surfaces of the optical fiber (100) have already been aligned vertically to match the vertical clamping surfaces of the fiber tensioning clamp (960). The fiber tensioning clamp (960) applies an appropriate tensile stress to the fiber by pulling on it horizontally along the axis of the optical fiber (100) in the direction (980) away from the second fiber holder position (940). With the proper tension applied, the cleaver blade (950) is engaged against the surface of the optical fiber (100) to perform the cleave.

With this process, the CleaveMaster can typically perform cleaving operations such that the cleave angles are within 0.5° of perpendicular to the optical axis of the optical fiber (100). However, the CleaveMaster is not designed for optical fibers with cladding diameters that are less than 250 μm. In addition, the image processing system and the fiber rotation system are very complicated and expensive, resulting in a very expensive cleaver. It is also difficult to maintain the proper edge illumination of the hexagonal or octagonal optical fiber such that a clearly defined image as shown in FIG. 8 is obtained. If such a clearly defined image is not obtained, the CleaveMaster cannot analyze the fiber shape and perform the rotational alignment. Further, since the fiber retains the original non-circular shape after cleaving, the CleaveMaster does not meet the splicing requirements for fiber core alignment and polarization alignment.

Because of the drawbacks of the CleaveMaster, most operators who cleave hexagonal or octagonal optical fibers manually rotate the fiber by hand to attempt to align the flat surfaces of the optical fiber to the flat surfaces of the cleaver clamps. Because even a 400 μm diameter fiber is very small, this operation is very tedious, difficult, and dependent upon the skill and eyesight of the operator. The operator typically looks for a reflection from a flat surface of the fiber cladding in order to determine the rotational orientation of the fiber. Manual rotational alignment performed by this method is not repeatable. While cleave angles of less than 0.5° are desirable, this manual rotational alignment often results in cleave angles of 2° or more.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a method of thea ictally rounding a non-circular shaped optical fiber. According to an aspect of the present invention, there is provided a method of rounding a section of a non-circular optical fiber, the method including heating the section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular.

The cross-section of the inner cladding of the optical fiber may be hexagonal or octagonal before the heating of the section of the optical fiber, or it may have a more complicated shape such as a multi-faceted star shape. The method may also include measuring a non-circularity of the cross-section of the inner cladding of the section of the optical fiber after the heating of the section of the optical fiber. The non-circularity may be measured by rotating the optical fiber at incremental rotation angles, obtaining an image profile of the cross-section of the inner cladding of the section of the optical fiber at each rotation angle, and using the image profiles to measure a diameter of the inner cladding of the section of the optical fiber at each rotation angle. The non-circularity may be not greater than 0.7% or 0.3% after the heating of the section of the optical fiber. The method may also include repeating the heating of the section of the optical fiber if the non-circularity is greater than a threshold value.

The heat source may include a pair of electrodes that are positioned on opposite sides of the optical fiber. Alternatively, the heat source may include a laser. Alternatively, the heat source may include a flame. Alternatively, the heat source may include a filament.

The optical fiber may be rotated during the heating of the section of the optical fiber. The optical axis of the optical fiber may be aligned substantially parallel to a direction of gravity during the heating of the section of the optical fiber. The method may also include applying a force parallel to the optical axis of the optical fiber to at least one end of the optical fiber during the heating of the section of the optical fiber, such that the optical fiber becomes elongated along the optical axis of the optical fiber. The sweeping motion may be performed iteratively such that discrete intervals within the section of the optical fiber are heated individually. Alternatively, the sweeping motion may be performed in a single continuous motion over the entire section of the optical fiber.

According to another aspect of the present invention, there is provided a method of cleaving a non-circular optical fiber, the method including heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; and cleaving the optical fiber at a position within the section of the optical fiber that has been heated.

According to another aspect of the present invention, there is provided a method of cleaving a non-circular optical fiber, the method including heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; clamping the optical fiber in a cleaver such that a clamp of the cleaver contacts only the section of the optical fiber that has been heated; and cleaving the optical fiber while the optical fiber is clamped in the cleaver.

According to another aspect of the present invention, there is provided a method of splicing a non-circular optical fiber to another component, the method including heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; and joining the optical fiber to the other component at a position within the section of the optical fiber that has been heated. The method may also include aligning a polarization direction of the optical fiber with a polarization direction of the other component before the joining of the optical fiber to the other component. The method may also include aligning a core of the optical fiber with a core of the other component before the joining of the optical fiber to the other component. The method may also include cleaving the optical fiber at the position within the section of the optical fiber before the joining of the optical fiber to the other component. A single splicer may be used to perform the heating of the section of the optical fiber and the joining of the optical fiber to the other component.

According to another aspect of the present invention, there is provided a method of splicing a non-circular optical fiber to another component, the method including heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; clamping the optical fiber in a cleaver such that a clamp of the cleaver contacts only the section of the optical fiber that has been heated; cleaving the optical fiber while the optical fiber is clamped in the cleaver; and joining the optical fiber to the other component at a position where the optical fiber has been cleaved. A single splicer may be used to perform the heating of the section of the optical fiber and the joining of the optical fiber to the other component.

### BRIEF DESCRIPTION OF THE DRAWINGS

The above and other aspects of the present invention will become more apparent by describing in detail exemplary embodiments thereof with reference to the attached drawings in which:

FIG. 1 shows an example of an optical fiber that is used in telecommunications;

FIG. 2 shows an example of a double-clad optical fiber;

FIG. 3A shows an example of a double-clad optical fiber with a hexagonal inner cladding;

FIG. 3B shows an example of a double-clad optical fiber with an octagonal inner cladding;

FIG. 4 shows the application of the PAS method to a single mode optical fiber;

FIG. 5 shows the application of the PAS method to a polarization-maintaining PANDA optical fiber;

FIG. 6 shows images of two PANDA fibers that have been aligned by the PAS method shown in FIG. 5;

FIG. 7 shows a schematic representation of the CleaveMaster cleaver;

FIG. 8 shows an image of the inner cladding of an octagonal optical fiber measured by the optical system of the CleaveMaster shown in FIG. 7;

FIG. 9 shows a method of rounding a section of a non-circular shaped optical fiber according to an exemplary embodiment of the present invention in which the optical fiber moves while the heat source is stationary to heat the optical fiber;

FIG. 10 shows the sagging of the optical fiber that may occur when the optical fiber is aligned horizontally during the heating of the optical fiber;

FIG. 11 shows a method of rounding a section of a non-circular shaped optical fiber according to another exemplary embodiment of the present invention in which the optical fiber is rotated during heating;

FIG. 12 shows a method of rounding a section of a non-circular shaped optical fiber according to another exemplary embodiment of the present invention in which the optical fiber is oriented vertically during heating;

FIG. 13 shows a method of rounding a section of a non-circular shaped optical fiber according to another exemplary embodiment of the present invention in which a laser is used as a heat source;

FIG. 14 shows a method of rounding a section of a non-circular shaped optical fiber according to another exemplary embodiment of the present invention in which a filament is used as a heat source;

FIG. 15 shows a method of rounding a section of a non-circular shaped optical fiber according to another exemplary embodiment of the present invention in which the optical fiber is stationary while the heat source moves to heat the optical fiber;

FIG. 16 shows a method of rounding a section of a non-circular shaped optical fiber according to another exemplary embodiment of the present invention in which a pair of electrodes is used as a heat source;

FIG. 17 shows a cross-section of a circular optical fiber;

FIG. 18 shows a cross-section of a hexagonal double-clad optical fiber;

FIG. 19A shows a cross-section of a section of a hexagonal double-clad optical fiber before rounding;

FIG. 19B shows the cross-section of the section of the hexagonal double-clad optical fiber shown in FIG. 19A after rounding;

FIG. 20 shows a graph of the diameter of the section of the hexagonal double-clad optical fiber before and after rounding;

FIG. 21A shows a cross-section of a section of a hexagonal double-clad PANDA fiber before rounding;

FIG. 21B shows the cross-section of the section of the hexagonal double-clad PANDA fiber shown in FIG. 21A after rounding;

FIG. 22 shows a graph of the diameter of the section of the hexagonal double-clad PANDA fiber before and after rounding; and

FIG. 23 shows a graph of the diameter of a section of an octagonal double-clad optical fiber before and after rounding.

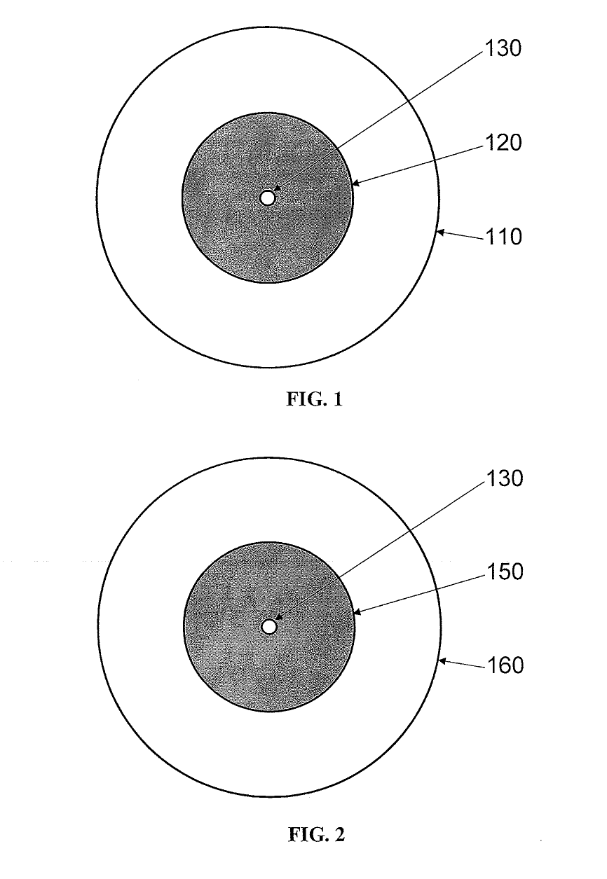

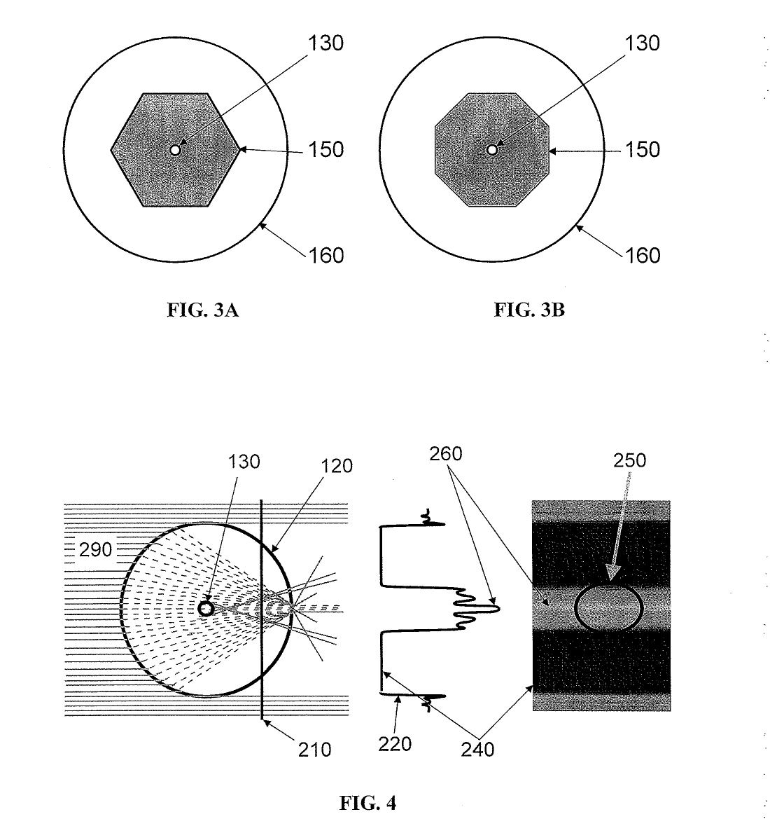

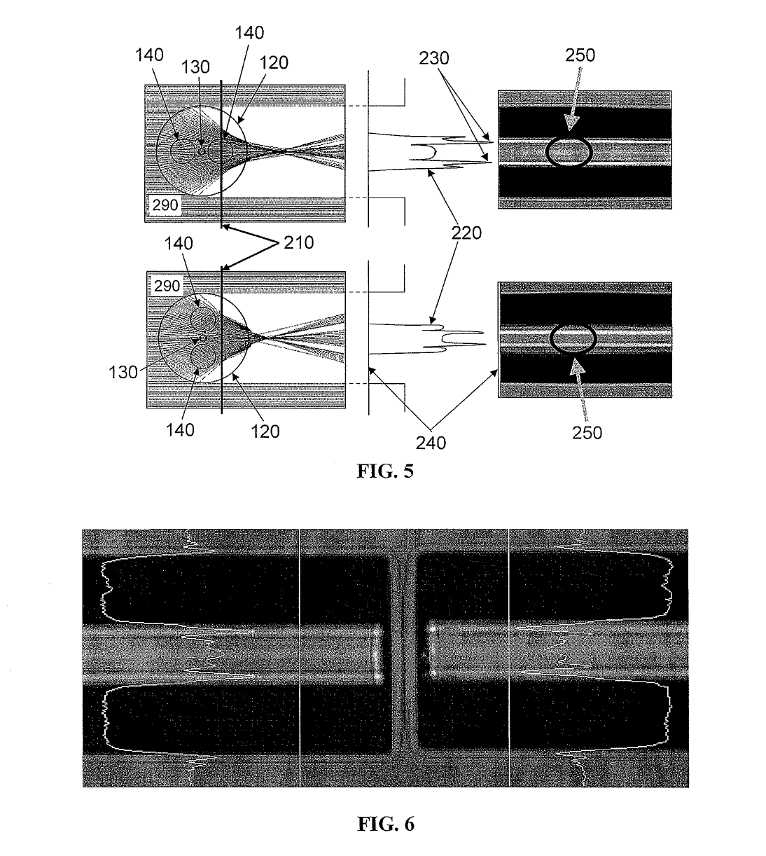

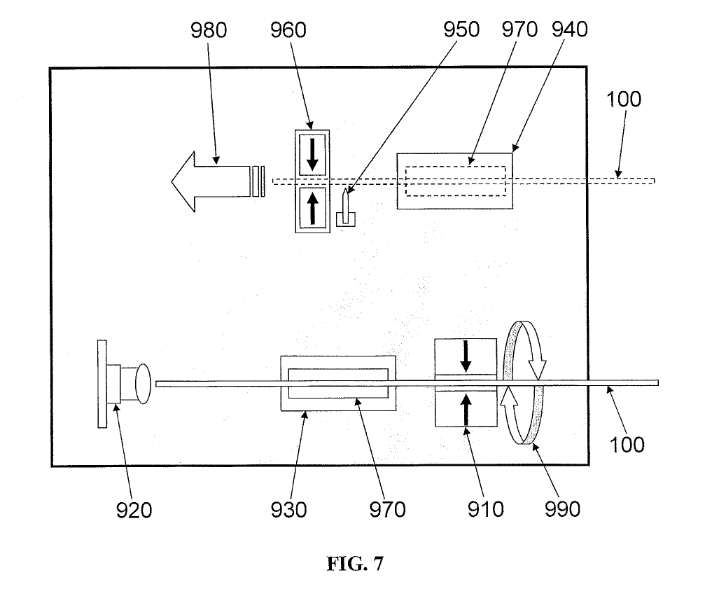

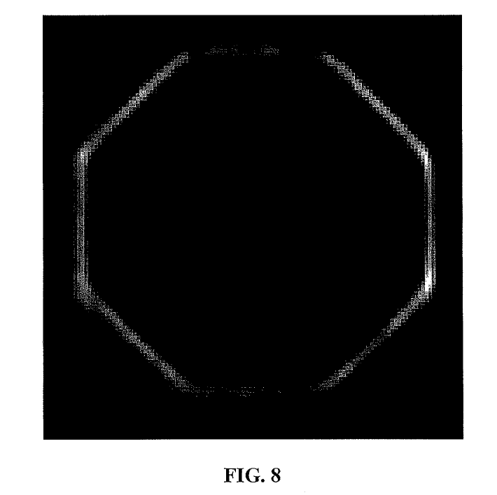

### DETAILED DESCRIPTION OF EXEMPLARY EMBODIMENTS OF THE INVENTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. However, the invention may be embodied in many different forms, and should not be construed as being limited to the exemplary embodiments set forth herein. In the drawings, like reference numerals denote like elements, and the thicknesses of layers and regions may be exaggerated for clarity and convenience.

According to an exemplary embodiment of the present invention, a method of thermally rounding a section of a non-circular shaped optical fiber is provided. This method is cost-effective, reliable, and semi-automated, and enables a non-circular shaped optical fiber to be cleaved and spliced with another component.

The glass material that forms the cladding of an optical fiber is an amorphous solid that liquefies when heated to a certain temperature. For example, most types of glass have a melting temperature above 1600° C. When an optical fiber is heated to an appropriate temperature near the melting temperature, the surface tension reduces the surface of the optical fiber to a minimum circumference, thereby rounding the optical fiber such that its cross-section becomes substantially circular.

According to an exemplary embodiment of the present invention, a section of a non-circular shaped optical fiber is thermally rounded by using a heat source to heat the section of the optical fiber with a sweeping motion along a direction parallel to the optical axis of the optical fiber. The optical fiber can move while the heat source remains stationary, or the heat source can move while the optical fiber remains stationary. Alternatively, both the optical fiber and the heat source can move during the heating of the section of the optical fiber. Additionally, the sweeping motion may be performed at discrete intervals within the section of the optical fiber, or in a single continuous motion over the entire section of the optical fiber.

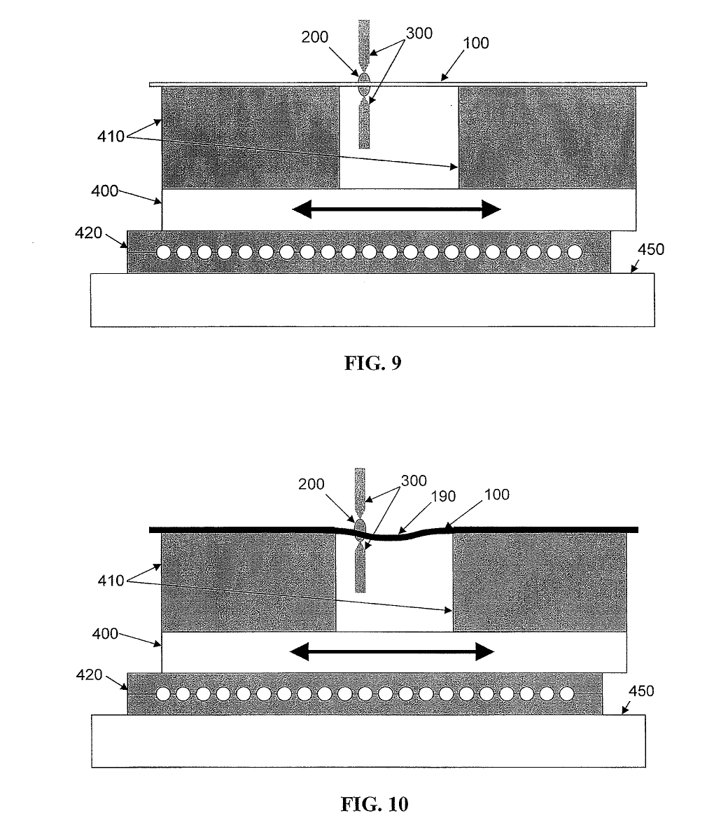

As shown in FIG. 9, the method of rounding a section of a non-circular shaped optical fiber (100) may include heating the optical fiber (100) with a sweeping motion by moving the optical fiber (100) along its optical axis while simultaneously heating the optical fiber (100), such as by an arc discharge (200) from a pair of fixed electrodes (300) on opposite sides of the optical fiber (100). For example, this method can change the shape of the cross-section of the section of the optical fiber (100) from hexagonal or octagonal to substantially circular. Once the section of the optical fiber (100) has a substantially circular cross-section, the optical fiber (100) can be cleaved and spliced with related art splicers and cleavers that are designed for circular fibers. In the apparatus shown in FIG. 9, two clamps (410) are used to clamp the optical fiber (100) on either side of the electrodes (300). The two clamps (410) are affixed to a movable translation stage (400). The movable translation stage (400) is mounted onto a bearing (420) which allows motion relative to a base (450). If the electrodes (300) are fixed to the base (450), the translation stage thereby moves the optical fiber (100) past the electrodes (300) and through the heating field of the arc discharge (200).

If the optical fiber (100) is held in a horizontal orientation during the heating and sweeping motion as shown in FIG. 9, the optical fiber (100) may sag due to gravity. This is illustrated by the sagging portion (190) of the optical fiber (100) in FIG. 10. If the optical fiber (100) sags and no longer has a straight optical axis, optical power carried by the optical fiber may be lost. In addition, cleaving of the optical fiber (100) may not be possible because the optical fiber (100) will not be straight relative to the clamps of the cleaver. Also, it will not be possible to recoat the optical fiber (100) to reconstitute the plastic coating or the outer plastic cladding. If the optical fiber (100) is not straight, it may also cause problems with subsequent packaging of the optical fiber (100) in a fiber laser or other optical device.

In an exemplary embodiment of the present invention, this sagging may be prevented by applying an outward axial tension to the fiber during the heating process. This may be accomplished by mounting at least one of the two clamps (410) on a bearing such that at least one of the two clamps (410) becomes an independent translation stage on top of the larger movable translation stage (400). At least one of the two clamps (410) can then be moved slightly away from the other clamp (410) to apply tension to the optical fiber (100). The optical fiber (100) can then be heated and translated as described above in order to round the surface. The axial tension may be applied by a spring or any other mechanism.

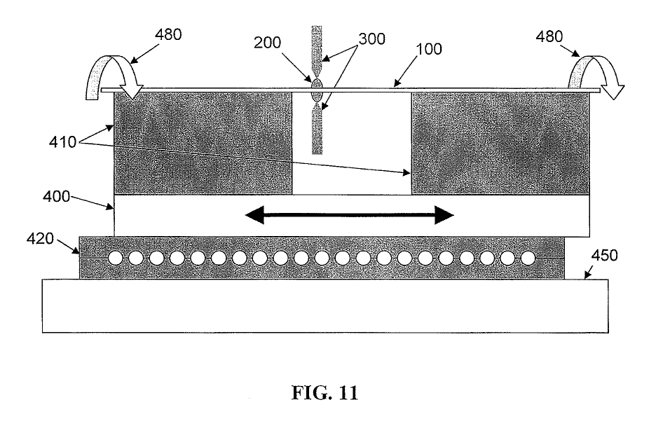

FIG. 11 shows another method of preventing the sagging problem described above. As shown in FIG. 11, the optical fiber (100) is again held horizontally. In the exemplary embodiment shown in FIG. 11, the sagging may be prevented by rotating the optical fiber (100) in a circular direction (480) about its optical axis during the heating. If the optical fiber (100) is rotated while being heated, the gravitational effect will be balanced and counteracted. This may be accomplished by integrating rotation mechanisms into the two clamps (410) which clamp the optical fiber (100).

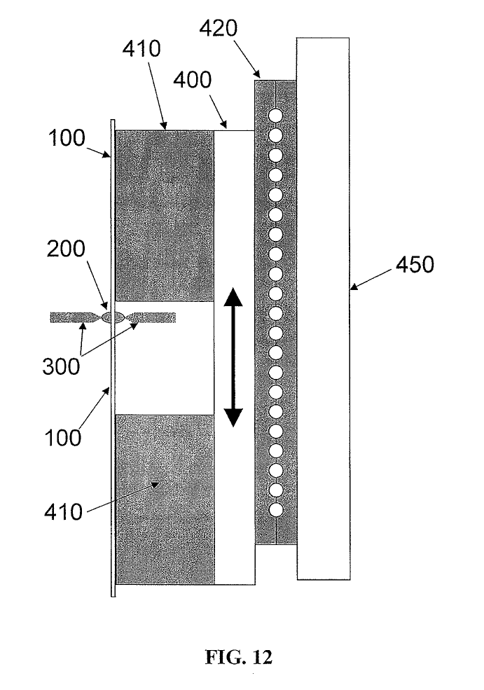

FIG. 12 shows another method of preventing the sagging problem described above. As shown in FIG. 12, the optical fiber (100) may be oriented vertically. In this case the gravitational force is directed along the axis of the optical fiber (100) and there is no tendency for the optical fiber (100) to bend as it is heated. With the optical fiber mounted vertically as shown in FIG. 12, the movable translation stage (400) moves vertically and carries the two clamps (410) and the optical fiber (100), thereby translating the optical fiber (100) vertically past the electrodes (300) and through the heating field of the arc discharge (200). Once again, the movable translation stage (400) is attached to a bearing (420) and translated relative to a base (450) to which the electrodes (300) are affixed. Because gravity affects the optical fiber (100) uniformly along its optical axis, the sagging of the optical fiber (100) is prevented.

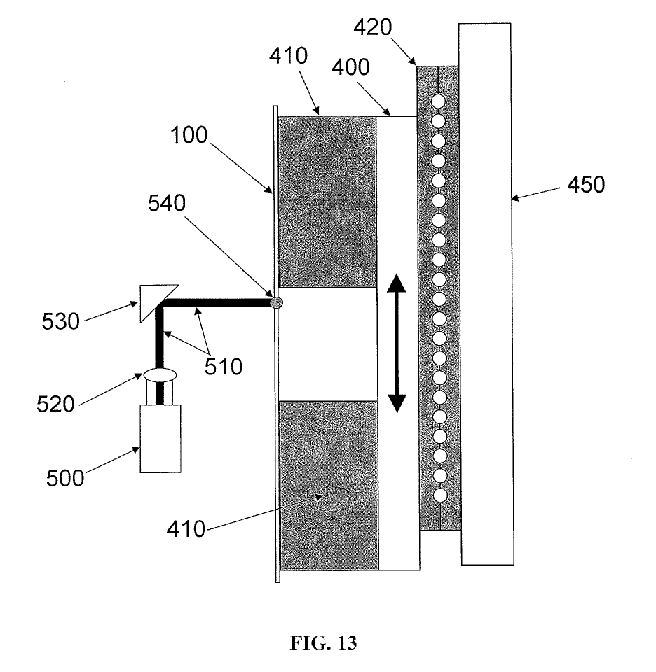

Any other suitable heat source may be used to heat the optical fiber (100) sufficiently to round the surface. In another exemplary embodiment of the invention as shown in FIG. 13, a laser (500) is used as the heat source for rounding the optical fiber (100). In this case the laser beam (510) is shaped and controlled by optical elements such as a lens (520), and the laser beam (510) may be directed towards the optical fiber (100) by a mirror (530) so that the concentrated and focused optical fiber creates a heating area (540) which heats and rounds the optical fiber.

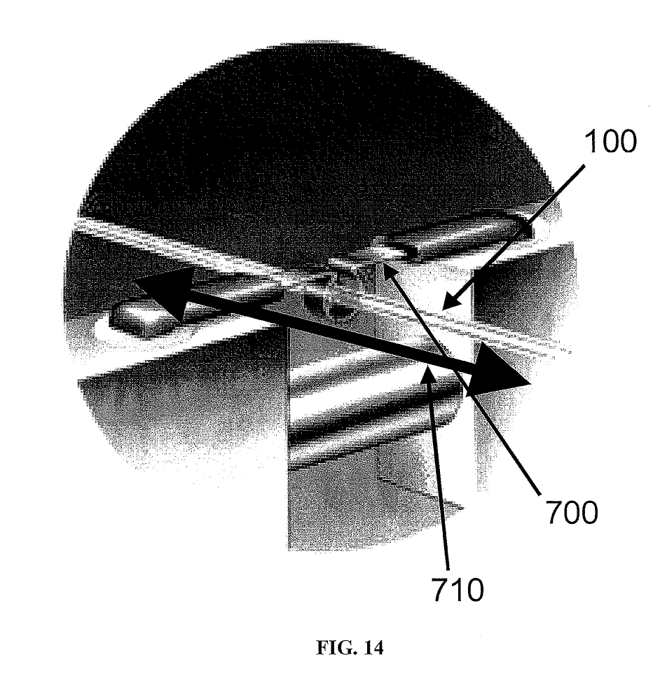

Alternatively, a gas flame may be used as the heat source to round the optical fiber (100). Also, as shown in FIG. 14, a filament (700) may be used as the heat source to round the optical fiber (100). Such filaments have been employed for splicing optical fibers, as well as for other fiber-related tasks. For these applications, the filament is typically shaped like the Greek letter Omega and the optical fiber (100) is disposed to pass through the center of the filament (700) as shown in FIG. 14. If the optical fiber (100) is translated along its optical axis in the direction (710) shown in FIG. 14 such that is passes through the filament (700), a section of the fiber may be heated and rounded.

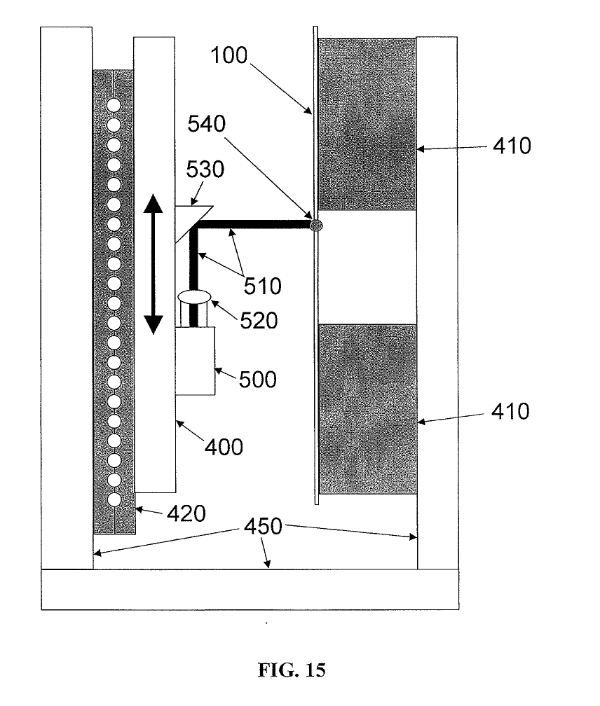

Another exemplary embodiment of the invention is shown in FIG. 15. In this case, the optical fiber (100) is held stationary with respect to the base (450) by the use of two clamps (410), and the heat source is moved relative to the fiber. In the example shown in FIG. 15, the heat source is a laser (500) with a lens (520) and a mirror (530). The laser (500), the lens (520), and the mirror (530) are mounted to the movable translation stage (400) which is attached to a bearing (420). The bearing (420) allows motion relative to the base (450). Translation of the movable translation stage (400) therefore moves the laser (500), the lens (520), and the mirror (530) so that the laser beam (510) and the concentrated and focused heating area (540) are scanned along the optical axis of the optical fiber (100).

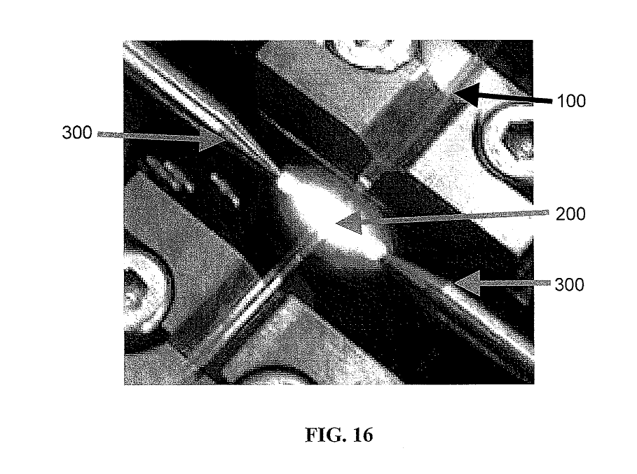

An exemplary embodiment of the present invention uses a fusion splicer to achieve an appropriate combination of heating power and sweeping speed in the thermal rounding method described above. An example of a fusion splicer used for this embodiment is shown in FIG. 16. An appropriate sweeping speed will prevent the optical fiber from overheating at certain locations, which could cause geometric non-uniformity along the optical axis or undesired core material thermal expansion. An appropriate combination of heating power and sweeping speed achieves a desired non-circularity for a shaped optical fiber with a specific diameter. If the heating power is too high and the sweeping speed is too low, the optical fiber may bend due to gravity as discussed above if it is oriented horizontally. Conversely, if the heating power is too low and the sweeping speed is too high, the optical fiber will have a large non-circularity because the optical fiber will retain some of its hexagonal or octagonal shape. This will cause a large cleave angle or a misalignment of the core and the stress rod due to image deformation by the non-circular fiber cladding. Further, if the heating power or sweeping speed is unstable, an undesired attenuation to either the cladding modes or the core modes can be created due to the mode field variation. Therefore, the heating power and sweeping speed should be as stable as possible.

An appropriate combination of heating power and sweeping speed is different for different types and sizes of optical fibers. These parameters also vary based on the specifications of the fusion splicer used to perform the thermal rounding method described above. In order to assess the effectiveness of a particular combination of heating power and sweeping speed, the non-circularity of the optical fiber may be measured after performing the thermal rounding method discussed above.

The non-circularity of the optical fiber indicates the degree to which the cross-section of the inner cladding of the optical fiber differs from a circle. The non-circularity may be measured by using a software program to control the rotators of the fusion splicer to incrementally rotate the optical fiber and acquire images of the end of the rounded section of the optical fiber at each angle of rotation. The software program then measures the diameter of the inner cladding of the optical fiber along a specific direction within the images as a function of rotation angle. The non-circularity is derived from a graph of the diameter of the optical fiber as a function of rotation angle.

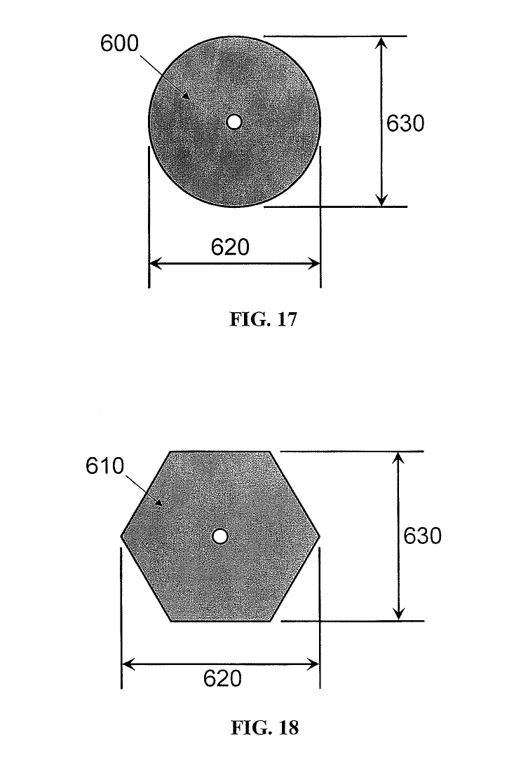

For a typical circular optical fiber, the non-circularity is preferably not greater than 0.7% for an optical fiber with a cladding having a diameter of 125 μm. This provides an optical fiber whose core and polarization direction can be aligned with another component. Similarly, a non-circular shaped optical fiber having an inner cladding diameter of 125 μm whose section is thermally rounded by the method described above may preferably have a non-circularity that is not greater than 0.7%. For a typical circular optical fiber, the non-circularity that may be present is due to some tolerance in the manufacturing process. The non-circularity of the typical circular fiber usually takes the form of slight ovality such that if the cross section is measured from different rotational orientations, there may be a major and minor axis. FIG. 17 shows a cross section of a typical circular optical fiber (600). Measurements of the diameter from two orthogonal axes (620, 630) may reveal that the fiber has a slightly larger diameter along one measurement axis (620) than the other measurement axis (630). The larger axis (620) may therefore be considered to be the major axis and may be defined as Dₘₐₓ. The smaller axis (630) may be considered to be the minor axis and may be defined as Dₘᵢₙ. If the percentage of non-circularity is defined as N_{c}, the calculation of the percentage of non-circularity is performed by equation (1) below:

$${N}_{c} = \frac{2 \cdot ( {D}_{max} - {D}_{min} )}{( {D}_{max} + {D}_{min} )} \times 100 \% \qquad ( 1 )$$

In the case of a typical circular fiber with a major axis dimension of 125.4 μm and a minor axis dimension of 124.6 μm, the calculation of the non-circularity based on equation (1) results in a percentage non-circularity of 0.64%.

The calculation of the non-circularity for a double-clad optical fiber with a hexagonal or an octagonal inner cladding is similar. For example, FIG. 18 shows a hexagonal fiber (610) with measurements of major axis (620) and minor axis (630). In the case of any hexagonal or octagonal fiber, the major axis (620) will be the dimension taken from corner-to-corner, and the minor axis (630) will be taken from flat surface to opposite flat surface. For a hexagonal or an octagonal fiber, the percentage of non-circularity is much greater than a circular fiber, since the hexagonal or octagonal fiber has been deliberately manufactured to have a non-circular shape. A typical hexagonal fiber with a diameter of 125 μm might have a major axis of 135 μm and a minor axis of 125 μm, resulting in a percentage non-circularity of 7.7%.

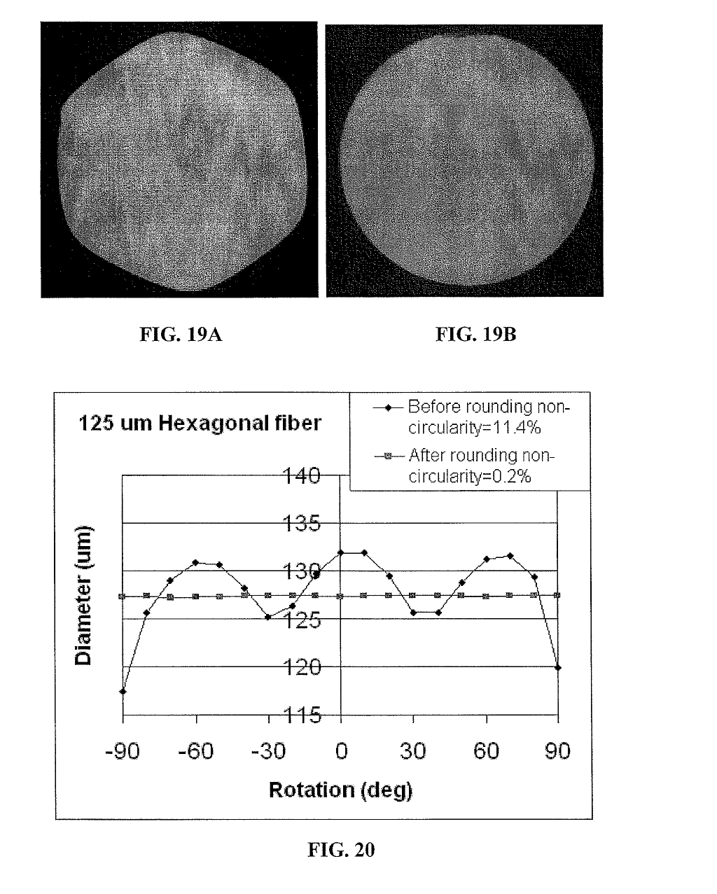

FIG. 19A shows an example of a cross-section of a section of a double-clad optical fiber with a hexagonal inner cladding having a diameter of 125 μm. FIG. 19B shows the cross-section of the section of the hexagonal double-clad optical fiber after being thermally rounded by the method discussed above. As shown in FIG. 19B, the cross-section of the section of the hexagonal double-clad optical fiber becomes substantially circular after rounding. FIG. 20 shows a graph of the diameter of the rounded section of the hexagonal double-clad optical fiber as a function of rotation angle. As shown in FIG. 20, the non-circularity of the section of the hexagonal double-clad optical fiber decreased from 14% before rounding to 0.3% after rounding. The typical cleave angle was measured to be 0.5 degrees, and the typical core offset after splicing was measured to be less 0.1 μm.

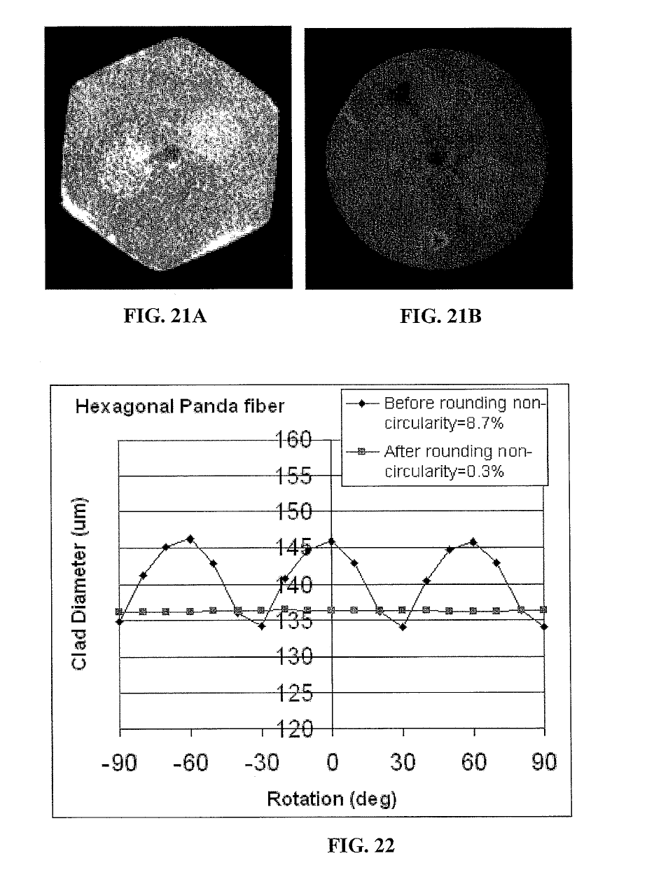

Similar results were achieved with a hexagonal double-clad PANDA fiber with a diameter of 135 μm. FIG. 21A shows the cross-section of a section of the hexagonal double-clad PANDA fiber before rounding, FIG. 21B shows the cross-section of the section of the hexagonal double-clad PANDA fiber after rounding, and FIG. 22 shows a graph of the diameter of the hexagonal double-clad PANDA fiber as a function of rotation angle. Again the non-circularity of the section of the hexagonal double-clad PANDA fiber after rounding is 0.3%, which makes it possible to perform polarization alignment with the same method as an ordinary circular PANDA fiber. The typical cleave angle was measured to be 0.5 degrees.

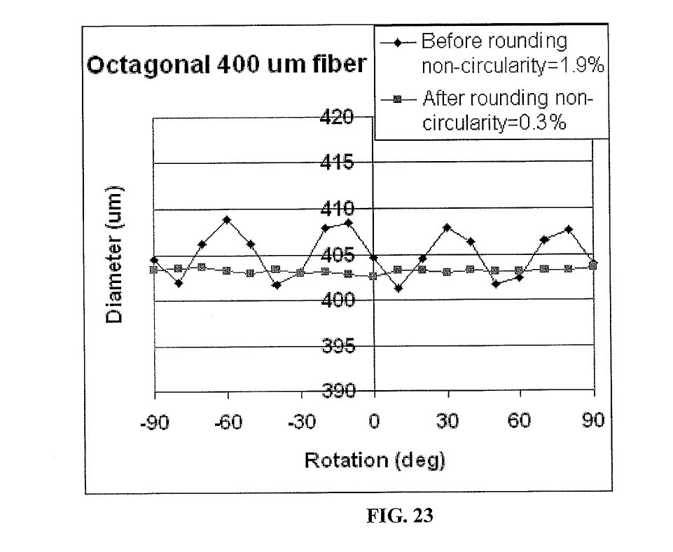

The rounding method according to exemplary embodiments of the present invention can also be applied to non-circular shaped optical fibers with large diameters. For example, an octagonal double-clad optical fiber having a cladding with a diameter of 400 μm was also thermally rounded and evaluated. FIG. 23 shows a graph of the diameter of the octagonal double-clad optical fiber as a function of rotation angle. As shown in FIG. 23, the non-circularity of the octagonal double-clad optical fiber was 0.3% after rounding. The heating power applied to the octagonal double-clad optical fiber was much higher than the heating power applied to the hexagonal fibers with smaller diameters. Due to its large diameter, the octagonal double-clad optical fiber was cleaved after being rounded once, and was then rounded at least once more in order to achieve a longer rounding length. The rounding length is preferably longer than the width of the v-groove clamp of the cleaver. This prevents the octagonal double-clad optical fiber from being twisted while the optical fiber is clamped in the cleaver, and enables consistently low cleave angles.

As discussed above, a section of a non-circular shaped optical fiber that is thermally rounded may preferably have a non-circularity below a desired value. If the non-circularity measurement indicates that the non-circularity of the thermally rounded optical fiber is greater than this value, the heating power and the sweeping speed can be adjusted. For example, if the optical fiber has not been sufficiently rounded because not enough heat was applied, the method can be repeated until the non-circularity of the optical fiber is below the desired value. Also, if too much heat was applied, the heating power and the sweeping speed can be adjusted before thermally rounding subsequent optical fibers of the same type and diameter.

After a section of a non-circular shaped optical fiber has been thermally rounded by the method described above, the optical fiber can be cleaved and spliced with another component. In an exemplary embodiment of the present invention, the optical fiber may be cleaved at a location where the optical fiber was thermally rounded. The location of the cleave is preferably in an area of the optical fiber that can be observed by a camera to analyze the fiber for core and polarization alignment prior to splicing with another component. The optical fiber may then be spliced with another component. The same fusion splicer in which the section of the fiber was thermally rounded may also be used to splice the optical fiber with the other component. The optical fiber is preferably joined with the other component at the position where the optical fiber was cleaved.

In another exemplary embodiment of the present invention, the optical fiber may be positioned in a cleaver such that a clamp of the cleaver holds the optical fiber in the section that was heated by the thermal rounding method described above. In this case the clamp contacts only the section that was heated. Due to the fact that the clamp contacts only the section of the optical fiber that was heated and thermally rounded, no torsional stress will be applied to the optical fiber by the flat surfaces of the clamp. Therefore, good cleave quality is assured. The optical fiber may then be cleaved at any location, either within or outside of the section that was heated. In addition, the optical fiber may then be spliced with another component. The same fusion splicer in which the section of the fiber was thermally rounded may also be used to splice the optical fiber with the other component. The optical fiber is then joined with the other component at the position where the optical fiber was cleaved.

While the present invention has been particularly shown and described with reference to exemplary embodiments thereof, it will be understood by those of ordinary skill in the art that various changes in form and detail may be made therein without departing from the spirit and scope of the present invention as defined by the following claims and their legal equivalents.

What is claimed is:

1. A method of rounding a section of a non-circular optical fiber, the method comprising heating the section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular.

2. The method according to claim 1, wherein the cross-section of the inner cladding of the optical fiber is hexagonal or octagonal before the heating of the section of the optical fiber.

3. The method according to claim 1, further comprising measuring a non-circularity of the cross-section of the inner cladding of the section of the optical fiber after the heating of the section of the optical fiber.

4. The method according to claim 3, wherein the non-circularity is measured by rotating the optical fiber at incremental rotation angles, obtaining an image profile of the cross-section of the inner cladding of the section of the optical fiber at each rotation angle, and using the image profiles to measure a diameter of the inner cladding of the section of the optical fiber at each rotation angle.

5. The method according to claim 3, wherein the non-circularity is not greater than 0.7% after the heating of the section of the optical fiber.

6. The method according to claim 5, wherein the non-circularity is not greater than 0.3% after the heating of the section of the optical fiber.

7. The method according to claim 3, further comprising repeating the heating of the section of the optical fiber if the non-circularity is greater than a threshold value.

8. The method according to claim 1, wherein the heat source comprises a pair of electrodes that are positioned on opposite sides of the optical fiber.

9. The method according to claim 1, wherein the heat source comprises a laser.

10. The method according to claim 1, wherein the heat source comprises a flame.

11. The method according to claim 1, wherein the heat source comprises a filament.

12. The method according to claim 1, wherein the optical fiber is rotated during the heating of the section of the optical fiber.

13. The method according to claim 1, wherein the optical axis of the optical fiber is aligned substantially parallel to a direction of gravity during the heating of the section of the optical fiber.

14. The method according to claim 1, further comprising applying a force parallel to the optical axis of the optical fiber to at least one end of the optical fiber during the heating of the section of the optical fiber, such that the optical fiber becomes elongated along the optical axis of the optical fiber.

15. The method according to claim 1, wherein the sweeping motion is performed iteratively such that discrete intervals within the section of the optical fiber are heated individually.

16. The method according to claim 1, wherein the sweeping motion is performed in a single continuous motion over the entire section of the optical fiber.

17. A method of cleaving a non-circular optical fiber, the method comprising:
heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; and
cleaving the optical fiber at a position within the section of the optical fiber that has been heated.

18. A method of cleaving a non-circular optical fiber, the method comprising:
heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular;
clamping the optical fiber in a cleaver such that a clamp of the cleaver contacts only the section of the optical fiber that has been heated; and
cleaving the optical fiber while the optical fiber is clamped in the cleaver.

19. A method of splicing a non-circular optical fiber to another component, the method comprising:
heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular; and
joining the optical fiber to the other component at a position within the section of the optical fiber that has been heated.

20. The method according to claim 19, further comprising aligning a polarization direction of the optical fiber with a polarization direction of the other component before the joining of the optical fiber to the other component.

21. The method according to claim 19, further comprising aligning a core of the optical fiber with a core of the other component before the joining of the optical fiber to the other component.

22. The method according to claim 19, further comprising cleaving the optical fiber at the position within the section of the optical fiber before the joining of the optical fiber to the other component.

23. The method according to claim 19, wherein a single splicer is used to perform the heating of the section of the optical fiber and the joining of the optical fiber to the other component.

24. A method of splicing a non-circular optical fiber to another component, the method comprising:
heating a section of the optical fiber with a sweeping motion along a direction substantially parallel to an optical axis of the optical fiber by at least one of moving the optical fiber with respect to a heat source and moving the heat source with respect to the optical fiber, such that a cross-section of an inner cladding of the section of the optical fiber becomes substantially circular;
clamping the optical fiber in a cleaver such that a clamp of the cleaver contacts only the section of the optical fiber that has been heated;
cleaving the optical fiber while the optical fiber is clamped in the cleaver; and
joining the optical fiber to the other component at a position where the optical fiber has been cleaved.

25. The method according to claim 24, wherein a single splicer is used to perform the heating of the section of the optical fiber and the joining of the optical fiber to the other component.
